(19) United States
(12) Patent Application Publication
(10) Pub. No.: US 2025/0056474 A1
(43) Pub. Date: Feb. 13, 2025

(54) REDUCED IMPACT ON POSITIONING ACCURACY IN TELECOMMUNICATIONS SYSTEMS

(71) Applicant: Nokia Technologies Oy, Espoo (FI)

(72) Inventors: Jürgen HOFMANN, Merching (DE); Daejung YOON, Massy (FR); Johannes HARREBEK, Aalborg (DK)

(21) Appl. No.: 18/721,418

(22) PCT Filed: Dec. 21, 2021
(86) PCT No.: PCT/EP2021/086990

§ 371 Date: Jun. 18, 2024

(51) Int. Cl. H04W 64/00; H04L 5/00; H04W 24/10; H04W 36/32; H04W 76/20

(52) U.S. Cl. CPC H04W 64/00; H04L 5/0051; H04W 24/10; H04W 36/324; H04W 76/20

(57) ABSTRACT

Determining positioning of a UE in a network includes the UE transmitting mobility status information to a LMF. A wireless network broadcasts configuration parameters for a set of mobility indicators. A receiving UE evaluates the configuration parameters and derives mobility status information, which the UE reports to the LMF. The LMF then determines positioning frequency layer and positioning reference signal configurations on DL (PRS) and UL (SRS). The LMF then sends the positioning frequency layer and reference signal configurations for DL and/or UL and positioning measurement and reporting configurations to the UE, its serving gNB and configured neighbour gNBs. The UE and gNB(s) then perform positioning measurements according to the positioning reference signal configurations for DL and/or UL and according positioning measurement and reporting configurations and report the positioning measurements to the LMF to determine the UE's position in the wireless network.

### TECHNICAL FIELD

This description relates to telecommunications systems.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, e.g., above 6 GHz. For fifth generation wireless systems (5G), an access architecture for deployment of cellular radio equipment employing mmWave radio spectrum has been proposed. Other example spectrums may also be used, such as cmWave radio spectrum (e.g., 3-30 GHz).

### SUMMARY

According to an example implementation, a method includes receiving, by a user equipment from a location management node for a wireless network, configuration parameters for a set of mobility indicators, the set of mobility indicators providing mobility status information to the location management node. The method further includes evaluating, by the user equipment, the configuration parameters to produce the mobility status information. The method further includes transmitting, by the user equipment to the location management node, the mobility status information. The method further includes receiving, by the user equipment from the location management node, (i) positioning reference signal configurations for downlink and/or uplink (ii) positioning measurement and reporting configurations for downlink and/or uplink. The method further includes performing, by the user equipment, a positioning measurement according to the positioning reference signal configurations for downlink and/or uplink and according to the positioning measurement and reporting configurations, the positioning measurements being used to determine a position of the user equipment in the wireless network and being reported to the location management node.

According to an example implementation, an apparatus includes at least one processor and at least one memory including computer program code, the at least one memory and the computer program code configured to, with the at least one processor, cause the apparatus at least to receive, by a user equipment from a location management node for a wireless network, configuration parameters for a set of mobility indicators, the set of mobility indicators providing mobility status information to the location management node. The at least one memory and the computer program code are further configured to, with the at least one processor, cause the apparatus at least to evaluate, by the user equipment, the configuration parameters to produce the mobility status information. The at least one memory and the computer program code are further configured to, with the at least one processor, cause the apparatus at least to transmit, by the user equipment to the location management node, the mobility status information. The at least one memory and the computer program code are further configured to, with the at least one processor, cause the apparatus at least to receive, by the user equipment from the location management node, (i) positioning reference signal configurations for downlink and/or uplink and (ii) positioning measurement and reporting configurations for downlink and/or uplink. The at least one memory and the computer program code are further configured to, with the at least one processor, cause the apparatus at least to perform, by the user equipment, a positioning measurement according to the positioning reference signal configurations for downlink and/or uplinks and according to the positioning measurement and reporting configurations, the positioning measurement being used to determine a position of the user equipment in the wireless network and being reported to the location management node.

According to an example implementation, an apparatus includes means for receiving, by a user equipment from a location management node for a wireless network, configuration parameters for a set of mobility indicators, the set of mobility indicators providing mobility status information to the location management node. The apparatus also includes means for evaluating, by the user equipment, the configuration parameters to produce the mobility status information. The apparatus further includes means for transmitting, by the user equipment to the location management node, the mobility status information. The apparatus further includes means for receiving, by the user equipment from the location management node, (i) positioning reference signal configurations for downlink and/or uplink and (ii) positioning measurement and reporting configurations for downlink and/or uplink. The apparatus further includes means for performing, by the user equipment, a positioning measurement according to the positioning reference signal configurations for downlink and/or uplink and according to the positioning measurement and reporting configurations, the positioning measurements being used to determine a position of the user equipment in the wireless network and being reported to the location management node.

According to an example implementation, a computer program product includes a computer-readable storage medium and storing executable code that, when executed by at least one data processing apparatus, is configured to cause the at least one data processing apparatus to receive, by a user equipment from a location management node for a wireless network, configuration parameters for a set of mobility indicators, the set of mobility indicators providing mobility status information to the location management node. The executable code, when executed by at least one data processing apparatus, is further configured to cause the at least one data processing apparatus to evaluate, by the user equipment, the configuration parameters to produce the mobility status information. The executable code, when executed by at least one data processing apparatus, is further configured to cause the at least one data processing apparatus to transmit, by the user equipment to the location management node, the mobility status information. The executable code, when executed by at least one data processing apparatus, is further configured to cause the at least one data processing apparatus to receive, by the user equipment from the location management node, (i) positioning reference signal configurations for downlink and/or uplink and (ii) positioning measurement and reporting configurations for downlink and/or uplink. The executable code, when executed by at least one data processing apparatus, is further configured to cause the at least one data processing apparatus to perform, by the user equipment, a positioning measurement according to the positioning reference signal configurations for downlink and/or uplink and according to the positioning measurement and reporting configurations, the positioning measurement being used to determine a position of the user equipment in the wireless network and being reported to the location management node.

According to an example implementation, a method includes transmitting, by a location management node for a wireless network to a network node or a set of network nodes in the wireless network, configuration parameters for a set of mobility indicators, the set of mobility indicators providing mobility status information to the location management node. The method also includes receiving, by a location management node for a wireless network from a user equipment served by the network node, a set of mobility indicators for the user equipment, the set of mobility indicators for the user equipment providing mobility status information to the location management node for the user equipment in the wireless network. The method further includes generating, by the location management node, positioning reference signal configurations for downlink and/or uplink configured to, with positioning measurement and reporting configurations, provide instructions for the user equipment and network node or set of network nodes to perform positioning measurements to determine a position of the user equipment within the wireless network and being reported to the location management node.

According to an example implementation, an apparatus includes at least one processor and at least one memory including computer program code, the at least one memory and the computer program code configured to, with the at least one processor, cause the apparatus at least to transmit, by a location management node for a wireless network to a network node or set of network nodes in the wireless network, configuration parameters for a set of mobility indicators, the set of mobility indicators providing mobility status information to the location management node. The at least one memory and the computer program code are also configured to receive, by a location management node for a wireless network from a user equipment served by the network node, a set of mobility indicators for the user equipment, the set of mobility indicators for the user equipment providing mobility status information to the location management node for the user equipment in the wireless network. The at least one memory and the computer program code are further configured to generate, by the location management node, positioning reference signal configurations for downlink and/or uplink configured to, with positioning measurement and reporting configurations, provide instructions for the user equipment and network node or set of network nodes to perform positioning measurements to determine a position of the user equipment within the wireless network. and being reported to the location management node

According to an example implementation, an apparatus includes means for transmitting, by a location management node for a wireless network to a network node or set of network nodes in the wireless network, configuration parameters for a set of mobility indicators, the set of mobility indicators providing mobility status information to the location management node. The apparatus also includes means for receiving, by a location management node for a wireless network from a user equipment served by the network node, a set of mobility indicators for the user equipment, the set of mobility indicators for the user equipment providing mobility status information to the location management node for the user equipment in the wireless network. The apparatus further includes means for generating, by the location management node, positioning reference signal configurations for downlink and/or uplink configured to, with positioning measurement and reporting configurations, provide instructions for the user equipment and network node or set of network nodes to perform positioning measurements to determine a position of the user equipment within the wireless network and being reported to the location management node.

According to an example implementation, a computer program product includes a computer-readable storage medium and storing executable code that, when executed by at least one data processing apparatus, is configured to cause the at least one data processing apparatus to transmit, by a location management node for a wireless network to a network node or set of network nodes in the wireless network, configuration parameters for a set of mobility indicators, the set of mobility indicators providing mobility status information to the location management node. The executable code, when executed by at least one data processing apparatus, is also configured to cause the at least one data processing apparatus to receive, by a location management node for a wireless network from a user equipment served by the network node, a set of mobility indicators for the user equipment, the set of mobility indicators for the user equipment providing mobility status information to the location management node for the user equipment in the wireless network. The executable code, when executed by at least one data processing apparatus, is further configured to cause the at least one data processing apparatus to generate, by the location management node, positioning reference signal configurations for downlink and/or uplink configured to, with positioning measurement and reporting configurations, provide instructions for the user equipment and network node or set of network nodes to perform positioning measurements to determine a position of the user equipment within the wireless network and being reported to the location management node.

According to an example implementation, a method includes receiving, by a network node or set of network nodes of a wireless network from a location management node for the wireless network, configuration parameters for a set of mobility indicators, the set of mobility indicators providing mobility status information to the location management node. The method also includes transmitting, by the network node or set of network nodes, via broadcast to a set of user equipments and/or via dedicated signalling to a user equipment, served by the network node or set of network nodes, the configuration parameters for the set of mobility indicators. The method further includes receiving, by the network node or set of network nodes from the location management node, (i) positioning reference signal configurations for downlink and/or uplink and (ii) positioning measurement and reporting configurations provided to the user equipment and the network node or set of network nodes, the positioning reference signal configurations and the positioning measurement and reporting configurations being based on the configuration parameters for the set of mobility indicators for a user equipment of the set of user equipments. The method further includes transmitting, by the network node or set of network nodes to the location management node, positioning measurements performed according to the positioning reference signal configurations for downlink and/or uplink and positioning measurement and reporting configurations.

According to an example implementation, an apparatus includes at least one processor and at least one memory including computer program code, the at least one memory and the computer program code configured to, with the at least one processor, cause the apparatus at least to receive, by a network node or set of network nodes of a wireless network from a location management node for the wireless network, configuration parameters for a set of mobility indicators, the set of mobility indicators providing mobility status information to the location management node. The at least one memory and the computer program code are also configured to transmit, by the network node or set of network nodes via broadcast to a set of user equipments and/or via dedicated signalling to a user equipment served by the network node or set of network nodes, the configuration parameters for the set of mobility indicators. The at least one memory and the computer program code are further configured to receive, by the network node or set of network nodes from the location management node, (i) positioning reference signal configurations for downlink and/or uplink and (ii) positioning measurement and reporting configurations provided to the user equipment and the network node or set of network nodes, the positioning reference signal configurations and the positioning measurement and reporting configurations being based on the configuration parameters for the set of mobility indicators for a user equipment of the set of user equipments. The at least one memory and the computer program code are further configured to transmit, by the network node or set of network nodes to the location management node, positioning measurements performed according to the positioning reference signal configurations for downlink and/or uplink and positioning measurement and reporting configurations.

According to an example implementation, an apparatus includes means for receiving, by a network node or set of network nodes of a wireless network from a location management node for the wireless network, configuration parameters for a set of mobility indicators, the set of mobility indicators providing mobility status information to the location management node. The apparatus also includes means for transmitting, by the network node or set of network nodes via broadcast to a set of user equipments and/or via dedicated signalling to a user equipment served by the network node or set of network nodes, the configuration parameters for the set of mobility indicators. The apparatus further includes means for receiving, by the network node or set of network nodes from the location management node, (i) positioning reference signal configurations for downlink and/or uplink and (ii) positioning measurement and reporting configurations provided to the user equipment and the network node or set of network nodes, the positioning reference signal configurations and the positioning measurement and reporting configurations being based on the configuration parameters for the set of mobility indicators for a user equipment of the set of user equipments. The apparatus further includes means for transmitting, by the network node or set of network nodes to the location management node, positioning measurements performed according to the positioning reference signal configurations for downlink and/or uplink and positioning measurement and reporting configurations.

According to an example implementation, a computer program product includes a computer-readable storage medium and storing executable code that, when executed by at least one data processing apparatus, is configured to cause the at least one data processing apparatus to receive, by a network node or set of network nodes of a wireless network from a location management node for the wireless network, configuration parameters for a set of mobility indicators, the set of mobility indicators providing mobility status information to the location management node. The executable code, when executed by at least one data processing apparatus, is also configured to cause the at least one data processing apparatus to transmit, by the network node or set of network nodes via broadcast to a set of user equipments and/or via dedicated signalling to a user equipment served by the network node or set of network nodes, the configuration parameters for the set of mobility indicators. The executable code, when executed by at least one data processing apparatus, is further configured to cause the at least one data processing apparatus to receive, by the network node or set of network nodes from the location management node, (i) positioning reference signal configurations for downlink and/or uplink and (ii) positioning measurement and reporting configurations provided to the user equipment and the network node or set of network nodes, the positioning reference signal configurations and the positioning measurement and reporting configurations being based on the configuration parameters for the set of mobility indicators for a user equipment of the set of user equipments. The executable code, when executed by at least one data processing apparatus, is further configured to cause the at least one data processing apparatus to transmit, by the network node or set of network nodes to the location management node, positioning measurements performed according to the positioning reference signal configurations for downlink and/or uplink and positioning measurement and reporting configurations.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a digital communications network according to an example implementation.

FIG. 2A is a diagram illustrating a scenario in which a UE is moving toward a gNB according to an example implementation.

FIG. 2B is a diagram illustrating a timing advance (TA) update command sent to the moving UE during the measurement procedure configured with a loop-based positioning (multi-RTT) method according to an example implementation.

FIG. 3 is a sequence diagram illustrating modifications to a signaling procedure for LPP Request Assistance Data and LPP Provide Assistance Data, according to an example implementation.

FIG. 4 is a sequence diagram illustrating an improved signalling procedure for positioning using mobility status information to determine suitable positioning transmission and reception parameters, according to an example implementation.

FIG. 5 is a flow chart illustrating a process of reducing mobility impact on positioning from the UE perspective according to an example implementation

FIG. 6 is a flow chart illustrating a process of reducing mobility impact on positioning from the LMF perspective according to an example implementation.

FIG. 7 is a flow chart illustrating a process of reducing mobility impact on positioning from the gNB perspective according to an example implementation.

FIG. 8 is a block diagram of a node or wireless station (e.g., base station/access point, relay node, or mobile station/user device) according to an example implementation.

### DETAILED DESCRIPTION

The principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

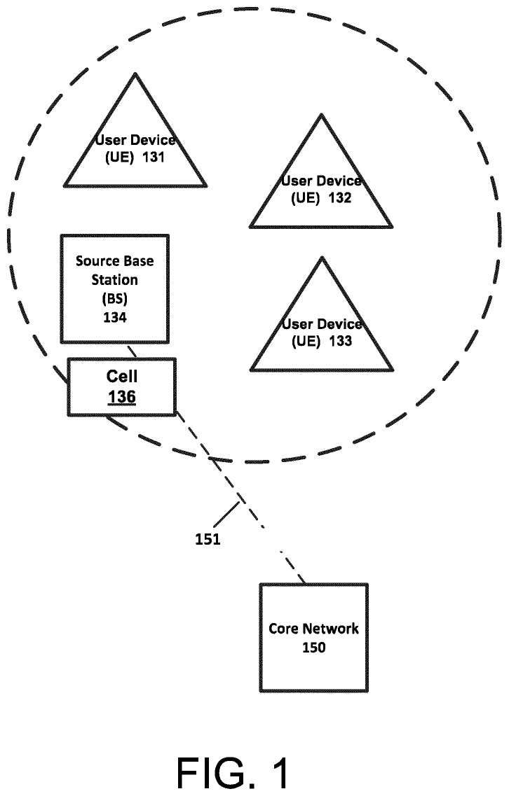

FIG. 1 is a block diagram of a digital communications system such as a wireless network 130 according to an example implementation. In the wireless network 130 of FIG. 1, user devices 131, 132, and 133, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e) Node B (eNB) may be also be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network 150 via an interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/serving cell change of user devices between BSs, one or more gateways that may forward data and control signals between the BSs and packet data networks or the Internet, and other control functions or blocks.

The various example implementations may be applied to a wide variety of wireless technologies, wireless networks, such as LTE, LTE-A, 5G (New Radio, or NR), cmWave, and/or mmWave band networks, or any other wireless network or use case. LTE, 5G, cmWave and mmWave band networks are provided only as illustrative examples, and the various example implementations may be applied to any wireless technology/wireless network. The various example implementations may also be applied to a variety of different applications, services or use cases, such as, for example, ultra-reliability low latency communications (URLLC), Internet of Things (IoT), time-sensitive communications (TSC), enhanced mobile broadband (eMBB), massive machine type communications (MMTC), vehicle-to-vehicle (V2V), vehicle-to-device, etc. Each of these use cases, or types of UEs, may have its own set of requirements.

Accurate positioning estimates are needed both for stationary UE's as well as slow- and fast-moving UE's.

NR positioning is introduced in 3GPP Rel-16 for RRC CONNECTED state with regard to introduction of UE assisted DL and UL positioning methods, such as DL-TDOA, DL-AOD, multi-RTT, UL-RTOA, UL AoA and E-CID, and of UE based positioning methods. New positioning reference signals PRS, for downlink transmission, and SRS, for UL transmission, are specified and related measurement requirements for UE and gNB were defined including measurement accuracy requirements for UE and gNB. In 3GPP Rel-17, NR positioning enhancements are investigated in terms of timing error mitigation for timing-based methods to improve measurement accuracy, in terms of latency reduction to improve response time and applicability of positioning in RRC INACTIVE. In this context, UE velocity may considerably impact positioning accuracy, as UE movement during the positioning procedure may create additional inaccuracy.

For stationary UE's, high positioning accuracy can be achieved, using for instance a wide PRS bandwidth, e.g., the full carrier bandwidth, while using a few measurement samples with a longer PRS periodicity by this reducing impact from radio channel changes and hence possibly decreasing number of required neighbour cells to be measured as a trade-off to reduce latency of the positioning response.

For moving UE's, in particular UE's moving at a higher speed, fast location estimation is important to reduce position uncertainty. If the moving speed is large enough to yield a significant difference in position during the measurement procedure, then additional positioning inaccuracy is added. In such case, the measurement procedure should be short in order to avoid timing advance (TA) updates during the measurement, for instance by using the following:
wider reference signal bandwidth, i.e. PRS bandwidth (DL) for UE measurements and SRS bandwidth (UL) for gNB measurements, and/or
increased number of measurement samples per cell, together with
increased frequency of DL/UL reference signals (i.e. PRS/SRS), allowing faster measurements, and/or
different transmission time offsets for DL/UL reference signals (i.e. PRS/SRS) of different cells, and/or
ensuring close proximity of DL/UL reference signals (i.e. PRS/SRS) to enable short measurement loops in case of configured loop-based positioning method (i.e. multi-RTT).

For multiple configured positioning frequency layers in serving and neighbor cells, differentiation according to UE velocity can be done:
In case of two positioning frequency layers, fast moving UEs are assigned to a different positioning frequency layer than stationary or low mobility UEs with both positioning frequency layers having different positioning reference signal configurations for DL/UL and positioning measurement and reporting configurations.
Further discrimination of UE velocities can be done in case of more than two positioning frequency layers configured in serving and neighbor cells.

Thus, the location management function (LMF) may send different PRS/SRS configurations to stationary and moving UE types upon or prior to a positioning request. To do this, the LMF has to be aware of the mobility characteristics of the UE(s).

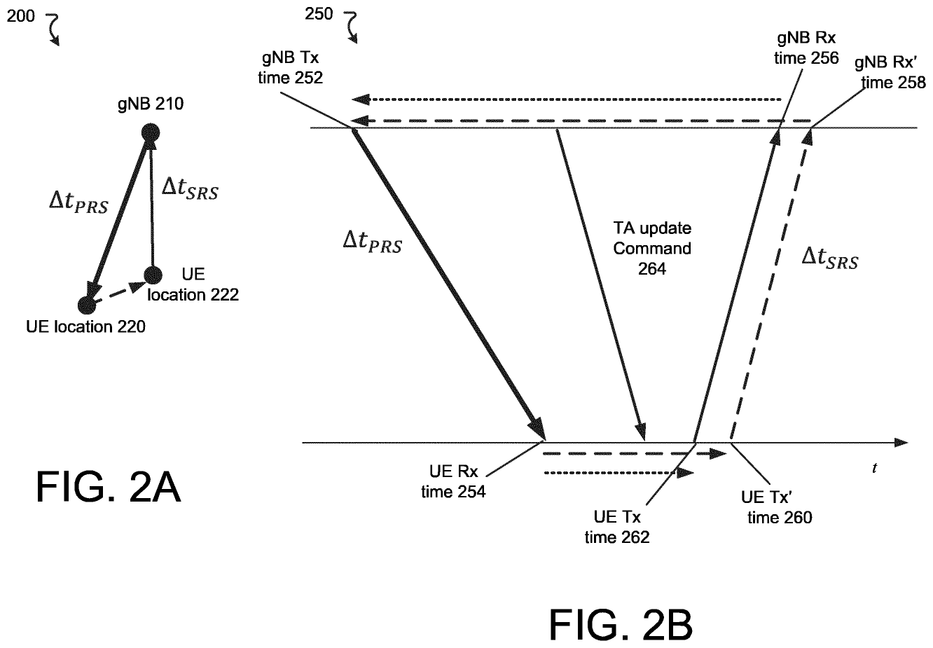

The impact of UE mobility on the positioning accuracy is further described below in an exemplary way for a UE configured with a loop-based positioning method. A (fast) moving UE is assumed, which UE is moving towards serving gNB, has been requested to perform a positioning measurement using a loop-based positioning method, i.e. multi-RTT. This scenario is illustrated in FIGS. 2A and 2B.

FIG. 2A is a diagram illustrating a scenario 200 in which a UE is moving toward a gNB 210 from a first UE location 220 to a second UE location 222. As shown in FIG. 2A, the gNB 210 transmits a downlink (DL) positioning reference signal (PRS) to the UE when the UE is at position 220; DL PRS has a propagation time Δt_{PRS}. When the UE is at position 222, the UE transmits an uplink (UL) sounding reference signal (SRS) to the gNB 210; the UL SRS has a propagation time Δt_{SRS}. When the UE is moving with a sufficiently large velocity, the difference between Δt_{PRS} and Δt_{SRS} may be significant.

FIG. 2B is a diagram illustrating a timing advance (TA) update command 264 sent to the UE, depicted in FIG. 2A moving closer toward gNB 210, during the measurement procedure configured with a loop-based positioning (multi-RTT) method 250. As shown in FIG. 2B, the gNB transmits a PRS (represented by the thick solid line) at gNB Tx time 252, to the UE which receives the PRS at UE Rx time 254. Prior reception of the TA update command, The UE then transmits with a configured time offset to PRS reception a SRS (represented by the thin solid line) at UE Tx time 262 to the gNB which receives the SRS at gNB Rx time 256.

Because the UE receives a TA update command 264, with a lower TA value, during the measurement procedure, however, the UE transmits the SRS at a later UE Tx′ time 260 to the gNB which receives the SRS at gNB Rx′ time 258.

The issue here is not that a TA update would falsify both gNB Rx-Tx time difference and UE Rx-Tx time difference measurements, as the TA update would still be compensated by both measurements (e.g. a higher TA reduces gNB Rx-Tx time, having a lower positive value, but increases UE Rx-Tx time, having a lesser negative value). Rather, the issue is that the appearance of the TA command during the measurement here represents an indicator for required transmit timing adjustment, which in this case is due to mobility, causing a difference in propagation time between PRS forward path Δt_{PRS} and SRS return path Δt_{SRS} and thus impacting the calculation in LMF.

For RTT, the calculated one-way propagation delay D_{calc} is

$${D}_{calc} = \frac{1}{2} ( Δ {t}_{PRS} + Δ {t}_{SRS} ) . \qquad ( 1 )$$

But this may yield a significant error in position accuracy in case of long measurement period (MP) and/or fast-moving UE, since the targeted ‘latest’ one-way propagation delay Dₜₐᵣ at the end of the measurement period is

$${D}_{tar} = Δ {t}_{SRS} . \qquad ( 2 )$$

The one-way propagation time error then is

$${D}_{calc} - {D}_{tar} = \frac{1}{2} ( Δ {t}_{PRS} + Δ {t}_{SRS} ) . \qquad ( 3 )$$

In Rel-16, RAN4 agreed that gNB accuracy requirements for multi-RTT, for the case that the UE receives a TA update command during the positioning measurement, do not apply. But for fast moving UE/long MP, this case may frequently appear. As the location server (LMF) has no further information on the current UE mobility status, it cannot distinguish the fast-moving UE from a stationary UE.

In contrast to the known conventional approaches to determine UE position when the UE is moving, an improved technique of determining UE position includes the UE transmitting mobility status information to a LMF prior to the UE receiving a positioning request from LMF. In some implementations, a wireless network broadcasts configuration parameters for a set of mobility indicators. A receiving UE evaluates the configuration parameters (e.g., through measurements) and derives mobility status information, which the UE reports to the LMF. The LMF determines positioning reference signal configurations on DL (PRS) and UL (SRS) and associated positioning measurement and reporting configurations from the mobility status information. The LMF then sends the positioning reference signal configurations and positioning measurement and reporting configurations to the UE, its serving gNB and the configured neighbour gNB(s) involved in the positioning procedure. The UE and gNBs then perform positioning measurements according to the positioning reference signal configurations and positioning measurement and reporting configurations and report the positioning measurements to the LMF.

Advantageously, the above-described improved technique for determining UE position improves the accuracy of positioning measurements by mitigating error due to the UE movement. During such movement, latency of the positioning procedure can also be reduced, and occupied radio resources can be used for other purposes after the positioning procedure has been completed. Without such mitigation provided in the improved techniques, the network would need to accommodate for a worst-case UE speed assumption, which is not always optimum, as this would have the cost of permanent extensive radio resource usage for positioning reference signals on DL and/or UL.

The mobility impact on positioning accuracy can be reduced, if the location management node (LMF) is aware of the UE mobility status through reception of mobility status information, sent as UE initiated assistance data information, prior to issuing the positioning request to the UE
in order to configure the gNB(s) and UE with suitable reference signal configurations for positioning, and.
in order to configure the UE and gNB(s) with most suitable measurement parameters,
   so that latency is reduced specifically for high mobility UEs. This has the effect of increasing positioning estimation accuracy. In some implementations, positioning accuracy is increased for stationary or quasi-stationary UE's by configuring additional resources for measurement, whenever the positioning latency requirement is not sufficiently strict.

To achieve this, the improved positioning technique includes the following:
1) The network broadcasts and/or signals in dedicated mode configuration parameters for a set of mobility indicators as part of the requested mobility status information. In some implementations, the set of mobility indicators depends on the RRC state (i.e., RRC_IDLE, RRC_INACTIVE, RRC_CONNECTED).
2) The UE evaluates the configured measurements according to its RRC state and derives the mobility status information.
3) The UE reports the mobility status information as part of the UE initiated assistance data information to the location server (LMF).
4) The LMF determines the positioning reference signal configurations on DL (PRS) and UL (SRS), i.e. the positioning frequency layer ID, PRS and SRS bandwidth and periodicity, number of PRS/SRS symbols and comb size, number of repetitions and PRS-SRS proximity) as well as the positioning measurement and reporting configurations (e.g. number of measurement samples, measurement gap configuration, reporting format) for the particular UE or a group of UE's based on the received mobility status information and other network constraints.
5) The LMF sends the determined configuration of the DL and UL positioning reference signal configurations as well as positioning measurement and reporting configurations to serving/neighbor gNBs involved in the positioning procedure and awaits their acknowledgement.
6) Upon acknowledgement, the LMF sends the DL and UL positioning reference signal configurations and positioning measurement and reporting configurations to the UE and awaits its acknowledgement.
7) The UE/gNB perform the measurements according to the signaled positioning reference signals and measurement configuration.
8) The gNB and UE report their respective positioning measurements to the LMF according to the signaled reporting configuration.

The mobility indicators may be any of the following.
Timing advance update rate for radial UE movement towards serving cell available in RRC_CONNECTED in the current 3GPP specification. In some implementations, the timing advance update rate is defined for RRC_INACTIVE and RRC_IDLE,
autonomous UL timing adjustment rate for the radial UE movement towards serving cell available in RRC_CONNECTED in the current 3GPP specification. In some implementations, it is defined for RRC_INACTIVE and RRC_IDLE,
beam ID and AoA change rate for horizontal and vertical UE movement towards serving cell and towards neighbor cells. In some implementations, they are available in RRC_IDLE, RRC_INACTIVE and RRC_CONNECTED,
neighbour cell TOA change rate, measured during SSB monitoring of neighbor cells. It is available in RRC_IDLE, RRC_INACTIVE and RRC_CONNECTED, e.g. for N strongest cells or for configured neighbor cells at different locations,
RSRP change rate, e.g., measuring SSB and/or CSI-RS reference signals for serving/neighbor cells,
velocity or doppler shift estimation (e.g., sensor or channel estimator),
acceleration estimation (e.g., accelerometer) to predict the velocity at the time of positioning measurement,
cell change frequency in connected/idle mode or handover frequency in connected mode,
or a combination of the above. Thus, mobility indicators are derived from serving cell mobility and/or neighbor cell mobility.

A set of suitable mobility indicators for positioning, which may depend on the RRC state of the UE, and a common reference observation period are configured by the network via broadcast and/or dedicated signaling. The UE composes the set of suitable mobility indicators according to its RRC state (RRC_IDLE/RRC_INACTIVE/RRC_CONNECTED).

Both threshold-triggered or periodic reporting of measurements for the signaled mobility indicators can be configured.

In some implementations, the set of suitable mobility indicators for positioning is available at UE prior to LMF sending the positioning request. In this case, latency at the time of the positioning request is reduced.

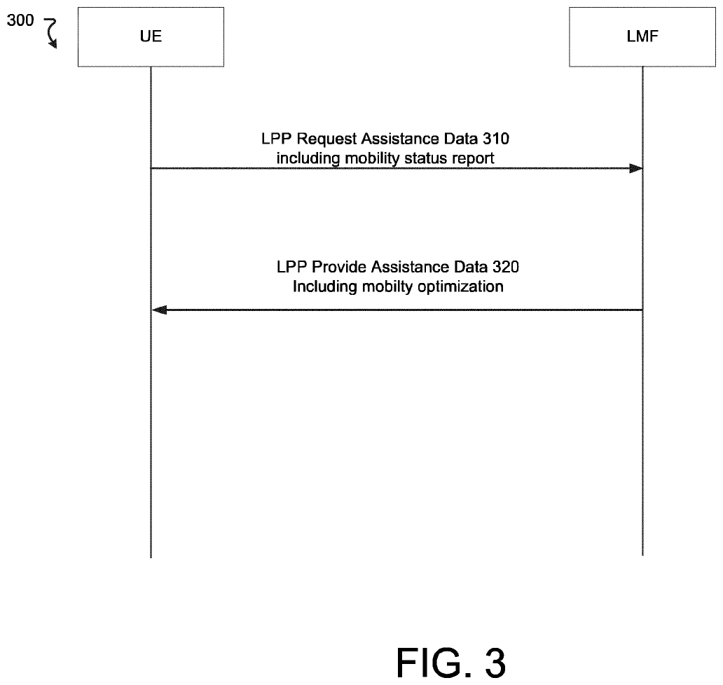

In some implementations, mobility status information is included in the UE initiated Assistance Data Transfer procedure (TS 38.305). In this way, the LMF is aware of the UE mobility prior to LMF sending the Positioning Request for defining the appropriate PRS/SRS and gNB/UE positioning measurement and reporting configurations. To this purpose, the UE sends the mobility status information, i.e., the requested set of configured mobility indicators, based on its RRC status, in the mobility status report as illustrated in FIG. 3.

FIG. 3 is a sequence diagram 300 illustrating modifications to a signalling procedure for LPP Request Assistance Data and LPP Provide Assistance Data. At 310, the UE sends a LPP Request Assistance Data to the LMF. This data includes a mobility status report; in some implementations, the mobility status report takes the form of a set of evaluated mobility indicators broadcast and/or signalled in dedicated mode by a serving network node. In some implementations, the mobility indicators include a TA update rate for the serving cell and/or a TOA change rate for a neighbour cell. At 320, the LMF transmits LPP Provide Assistance Data 320 to the UE. In some implementations, this data includes a mobility optimization for position determination via a set of DL and UL positioning reference signal configurations for DL and/or UL and positioning measurement and reporting configurations. In some implementations, the positioning reference signal configurations include a positioning frequency layer ID, a measurement sample rate, a PRS/SRS periodicity, and/or a PRS/SRS proximity.

In some implementations, the set of mobility indicators is common for all RRC states, in others, a case distinction on UE in RRC_IDLE/RRC_INACTIVE/RRC CONNECTED mode for determining the set of mobility indicators is done. For example:
If the UE is in RRC_IDLE/RRC_INACTIVE: a combination of Beam Change ID of the serving cell and of Neighbour cell TOA change rate, evaluated in the configured reference observation period, is used.
If the UE is in RRC_CONNECTED: a combination of Timing Advance update rate (e.g. based on number of recently received TA updates), Autonomous UL timing adjustment rate (recently executed timing adjustments) and Beam Change ID of the serving cell, evaluated in the configured reference observation period, is used.

In some implementations, to achieve this the LMF provides a set of mobility indicators to UE for all (three) RRC states (=3 different sets). The UE selects the set corresponding to its RRC state and reports the status for these indicators to the LMF. Hence, the LMF may conclude on RRC status of UE through the content of the mobility status report.

The set of evaluated mobility indicators is sent as mobility status report within a LPP Request Assistance Data message and this message may be processed by LMF. This set of mobility indicators may be taken into account in the LPP Provide Assistance Data message, in the mobility optimization parameter (e.g. the positioning frequency layer ID, add number of required measurement samples, PRS/SRS periodicity and PRS-SRS proximity configuration).

In some implementations, in case of a required change of PRS/SRS periodicity or change of proximity between DL/UL RS, the LMF will also update serving gNB and neighbour gNBs via NRPPa, e.g. within Positioning Information Request message.

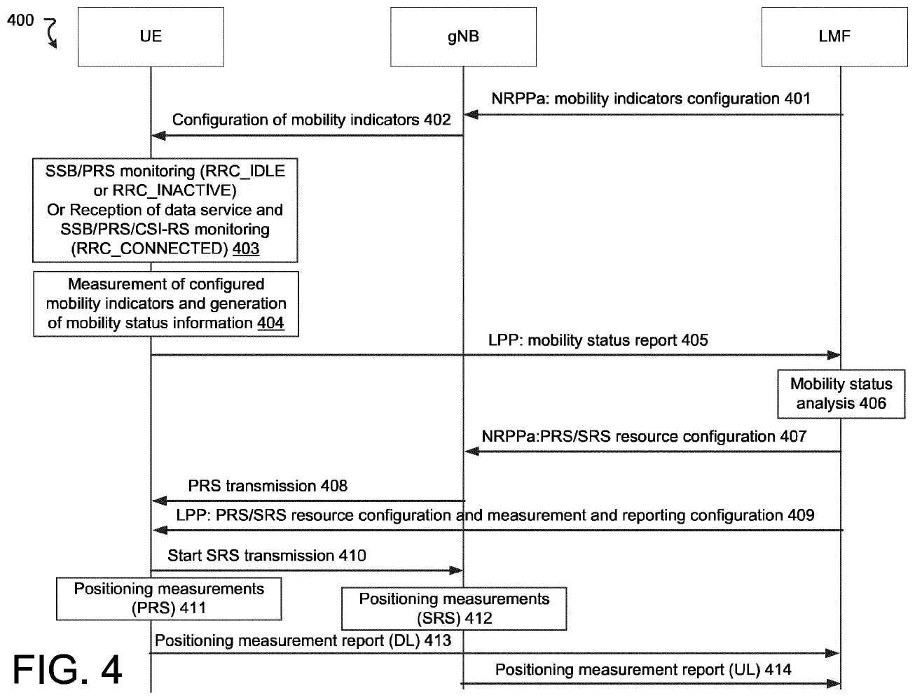

FIG. 4 is a sequence diagram illustrating an improved signalling procedure 400 for positioning using mobility status information to determine suitable positioning transmission and reception parameters.

At 401, the LMF transmits a message under NRPPa including configuration of mobility indicators to a gNB. The mobility indicators may include any of those listed above, alone or in combination.

At 402, the gNB broadcasts a message including the configuration of mobility indicators to the UEs it serves. The mobility indicators are selected for a UE served by the gNB and, in some implementations, is based on its RRC state.

At 403, the UE performs monitoring of SSB and/or PRS when the UE is in a RRC_IDLE or RRC_INACTIVE state, or the UE performs a reception of data service and a monitoring of SSB, PRS, and/or CSI-RS when the UE is in a RRC_CONNECTED state.

At 404, the UE measures configured mobility indicators and generates mobility status information based on the measurements of the configured mobility indicators. Examples of mobility indicators are presented above.

At 405, the UE reports the mobility status information as part of the UE initiated assistance data information to the LMF. As shown in FIG. 4, this is sent under LPP.

At 406, the LMF determines the positioning reference signal configurations on DL (PRS) and UL (SRS), i.e. the positioning frequency layer ID, PRS and SRS bandwidth and periodicity, number of PRS/SRS symbols and comb size, number of repetitions and PRS-SRS proximity) as well as positioning measurement and reporting configurations (e.g. number of measurement samples, measurement gap configuration, reporting format) for the particular UE or a group of UE's based on the received mobility status information and other network constraints.

At 407, the LMF transmits the determined configuration of the DL and UL positioning reference signal configurations for DL and/or UL as well as positioning measurement and reporting configurations to serving/neighbour gNBs involved in the positioning procedure.

At 408, the gNB begins transmission of a PRS to the UE.

At 409, after receiving an acknowledgement from the gNB, the LMF transmits the DL and UL positioning reference signal configurations and positioning measurement and reporting configurations to the UE. This is transmitted under LPP.

At 410, the UE begins transmission of a SRS to the serving gNB.

At 411, the UE performs positioning measurements on the PRS according to the positioning reference signal configurations and the measurement configuration received from the LMF.

At 412, the gNB performs positioning measurements on the SRS according to the positioning reference signal configurations and the measurement configuration received from the LMF.

At 413, the UE sends a DL positioning report to the LMF according to the signalled reporting configuration.

At 414, the gNB sends a UL positioning report to the LMF according to the signalled reporting configuration.

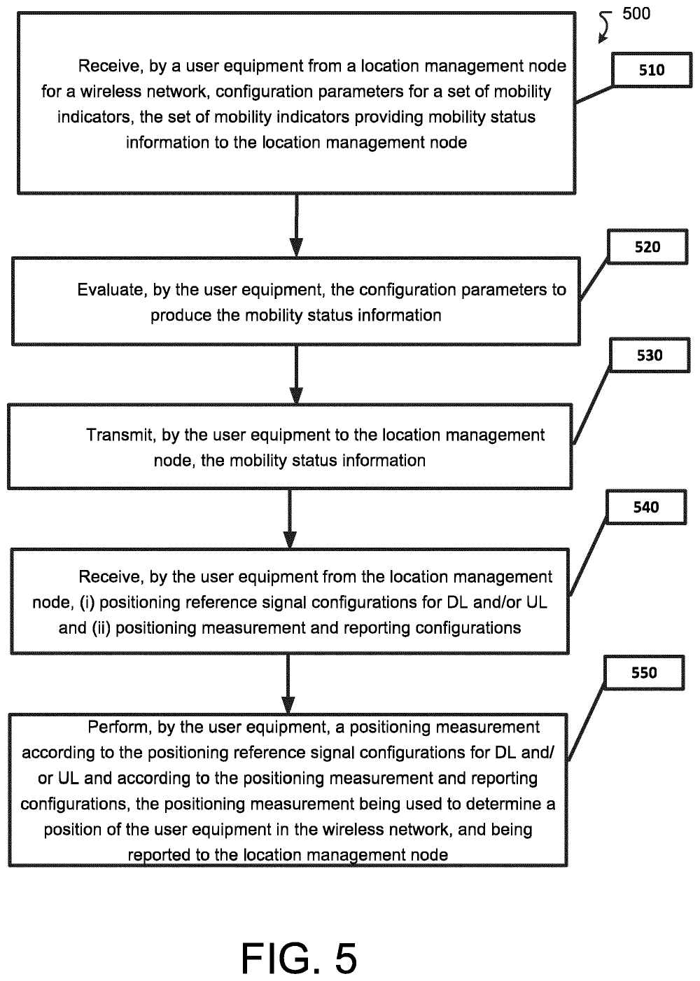

Example 1-1: FIG. 5 is a flow chart illustrating a process 500 of determining UE positioning in a wireless network. Operation 510 includes receiving, by a user equipment from a location management node for a wireless network, configuration parameters for a set of mobility indicators, the set of mobility indicators providing mobility status information to the location management node. Operation 520 includes evaluating, by the user equipment, the configuration parameters to produce the mobility status information. Operation 530 includes transmitting, by the user equipment to the location management node, the mobility status information. Operation 540 includes receiving, by the user equipment from the location management node, (i) positioning reference signal configurations for downlink and/or uplink and (ii) positioning measurement and reporting configurations. Operation 550 includes performing, by the user equipment, a positioning measurement according to the positioning reference signal configurations for downlink and/or uplink and according to the positioning measurement and reporting configurations, the positioning measurement being used to determine a position of the user equipment in the wireless network and being reported to the location management node.

Example 1-2: According to an example implementation of example 1-1, further comprising transmitting, to the location management node, the positioning measurements, the location management node being configured to derive the position of the user equipment in the network based on the positioning measurements from the user equipment and/or positioning measurements from serving and neighbor network nodes.

Example 1-3: According to an example implementation of examples 1-1 or 1-2, wherein the set of mobility indicators includes a timing advance update rate, the timing advance update rate indicates a radial movement of the user equipment toward a serving network node available in an RRC_CONNECTED state.

Example 1-4: According to an example implementation of examples 1-1 to 1-3, wherein the set of mobility indicators includes an autonomous uplink timing adjustment rate, the autonomous uplink timing adjustment rate indicates a radial movement of the user equipment toward a serving network node available in an RRC_CONNECTED state.

Example 1-5: According to an example implementation of examples 1-1 to 1-4, wherein the set of mobility indicators includes a beam identifier and a change rate of an angle of arrival indicating horizontal and vertical movement of the user equipment relative to a serving cell or neighbour cell location.

Example 1-6: According to an example implementation of examples 1-1 to 1-5, wherein the set of mobility indicators includes a time of arrival change rate for one or more neighbor cells of the serving cell for the user equipment.

Example 1-7: According to an example implementation of example 1-6, wherein the time of arrival change rate is measured during synchronization signal block monitoring of one or more neighbour cells of the serving cell for the user equipment.

Example 1-8: According to an example implementation of examples 1-1 to 1-7, wherein the set of mobility indicators includes a change rate of a reference signal received power measurement of at least one of a synchronization signal block or a channel state information reference signal.

Example 1-9: According to an example implementation of examples 1-1 to 1-8, wherein the set of mobility indicators includes a doppler shift estimator.

Example 1-10: According to an example implementation of examples 1-1 to 1-9, wherein the set of mobility indicators includes an acceleration estimator configured to predict a velocity of the user equipment at the time of the positioning measurement.

Example 1-11: According to an example implementation of examples 1-1 to 1-10, wherein the set of mobility indicators includes a frequency of cell changes or handovers when the user equipment is in one of RRC_CONNECTED, RRC_INACTIVE or RRC_IDLE state.

Example 1-12: According to an example implementation of examples 1-1 to 1-11, wherein the configuration parameters for the set of mobility indicators are based on the radio resource connection state of the user equipment.

Example 1-13: According to an example implementation of examples 1-1 to 1-12, wherein the configuration parameters are evaluated periodically at a specified period of time.

Example 1-14: According to an example implementation of examples 1-1 to 1-13, wherein the transmission of the mobility status information is performed after the configuration parameters have been evaluated.

Example 1-15: An apparatus comprising means for performing a method of any of examples 1-1 to 1-14.

Example 1-16: A computer program product including a non-transitory computer-readable storage medium and storing executable code that, when executed by at least one data processing apparatus, is configured to cause the at least one data processing apparatus to perform a method of any of examples 1-1 to 1-14.

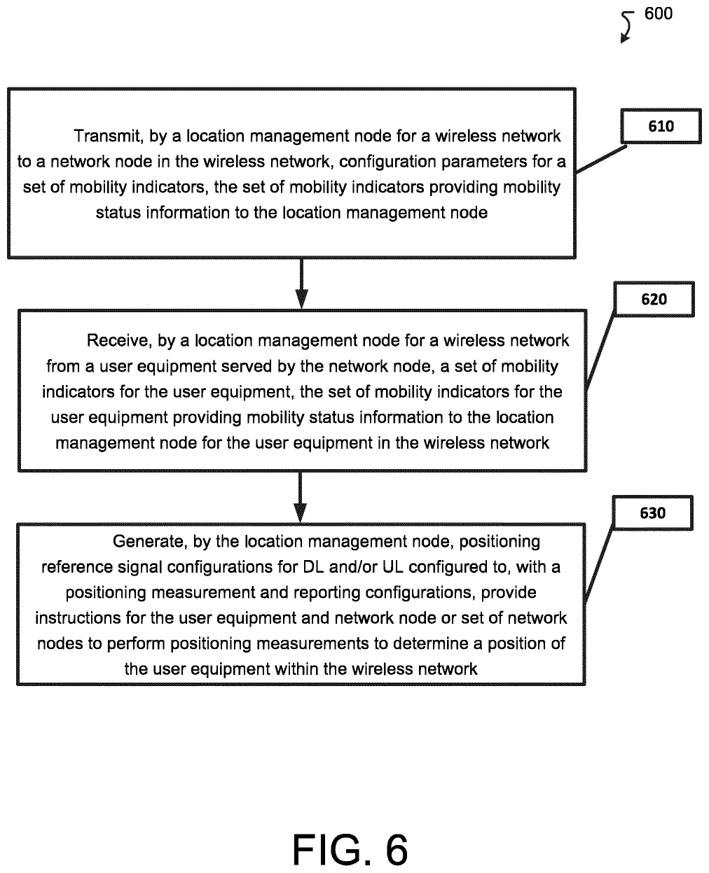

Example 2-1: FIG. 6 is a flow chart illustrating a process 600 of determining UE positioning in a wireless network. Operation 610 includes transmitting, by a location management node for a wireless network to a network node or set of network nodes in the wireless network, configuration parameters for a set of mobility indicators, the set of mobility indicators providing mobility status information to the location management node. Operation 620 includes receiving, by a location management node for a wireless network from a user equipment served by the network node, a set of mobility indicators for the user equipment, the set of mobility indicators for the user equipment providing mobility status information to the location management node for the user equipment in the wireless network. Operation 630 includes generating, by the location management node, positioning reference signal configurations for downlink and/or uplink configured to, with positioning measurement and reporting configurations, provide instructions for the user equipment and network node or set of network nodes to perform positioning measurements to determine a position of the user equipment within the wireless network.

Example 2-2: According to an example implementation of example 2-1, further comprising transmitting, by the location management node, (i) positioning reference signal configurations for downlink and/or uplink and (ii) positioning measurement and reporting configurations provided to the user equipment and the network node or set of network nodes; and receiving, from the user equipment and network node or set of network nodes, positioning measurements made by the user equipment and network node or set of network nodes according to the positioning reference signal configurations for downlink and/or uplink and positioning measurement and reporting configurations.

Example 2-3: According to an example implementation of examples 2-1 to 2-2, wherein generating the positioning reference signal configurations for downlink and/or uplink includes selecting positioning reference signal resources and/or sounding reference signal resources.

Example 2-4: According to an example implementation of examples 2-1 to 2-3, wherein the instructions for the user equipment and network node or set of network nodes to perform positioning measurements include, in response to the user equipment moving faster than a threshold velocity, instructions to increase a rate of performing positioning measurements.

Example 2-5: According to an example implementation of examples 2-1 to 2-4, wherein the instructions for the user equipment and network node or set of network nodes to perform positioning measurements include, in response to the user equipment moving faster than a threshold velocity, instructions to set a measurement gap pattern having a periodicity shorter than a threshold time.

Example 2-6: According to an example implementation of examples 2-1 to 2-5, wherein the instructions for the user equipment and network node or set of network nodes to perform positioning measurements include, in response to the user equipment moving at a velocity faster than a threshold velocity, instructions to assign a different positioning frequency layer for positioning measurements than the positioning frequency layer assigned in case of the velocity at which the user equipment moves is below the threshold velocity.

Example 2-7: An apparatus comprising means for performing a method of any of examples 2-1 to 2-6.

Example 2-8: A computer program product including a non-transitory computer-readable storage medium and storing executable code that, when executed by at least one data processing apparatus, is configured to cause the at least one data processing apparatus to perform a method of any of examples 2-1 to 2-6.

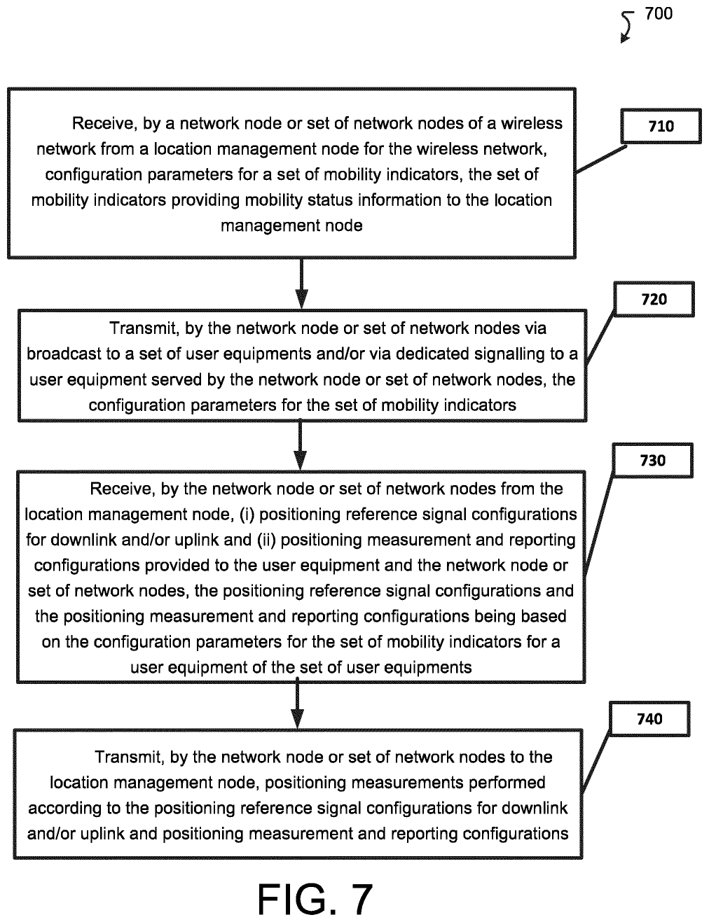

Example 3-1: FIG. 7 is a flow chart illustrating a process 700 of determining UE positioning in a wireless network. Operation 710 includes receiving, by a network node or set of network nodes of a wireless network from a location management node for the wireless network, configuration parameters for a set of mobility indicators, the set of mobility indicators providing mobility status information to the location management node. Operation 720 includes transmitting, by the network node or set of network nodes via broadcast to a set of user equipments and/or via dedicated signalling to a user equipment served by the network node or set of network nodes, the configuration parameters for the set of mobility indicators. Operation 730 includes receiving, by the network node from the location management node, (i) positioning reference signal configurations for downlink and/or uplink and (ii) positioning measurement and reporting configurations provided to the user equipment and the network node or set of network nodes, the positioning reference signal configurations and the positioning measurement and reporting configurations being based on the configuration parameters for the set of mobility indicators for a user equipment of the set of user equipments. Operation 740 includes transmitting, by the network node to the location management node, positioning measurements performed according to the positioning reference signal configurations for downlink and/or uplink and positioning measurement and reporting configurations.

Example 3-2: An apparatus comprising means for performing a method of example 3-1.

Example 3-3: A computer program product including a non-transitory computer-readable storage medium and storing executable code that, when executed by at least one data processing apparatus, is configured to cause the at least one data processing apparatus to perform a method of example 3-1.

### LIST OF EXAMPLE ABBREVIATIONS

AoD Angle of Departure
AMF Access & Mobility management Function
CSI Channel State Information
DL Downlink
E-CID Enhanced Cell ID
gNB next generation Node B
ID Identity
LMF Location Management Function
LPP LTE Positioning Protocol
MGL Measurement Gap Length
MGRP Measurement Gap Repetition Period
MP Measurement Period
NC Neighbour Cell
NRPPa NR Positioning Protocol A
PFL Positioning Frequency Layer
PRS Positioning Reference Signal
RRC Radio Resource Control
RRM Radio Resource Management
RSReference Signal
RTOA Relative Time of Arrival
RTT Round Trip Time
Rx Receive
SRS Sounding Reference Signal
SSB Synchronization Signal Block
TA Timing Advance
TOA Time Of Arrival
Tx Transmit
TDOA Time Difference Of Arrival
UE User Equipment
UL Uplink

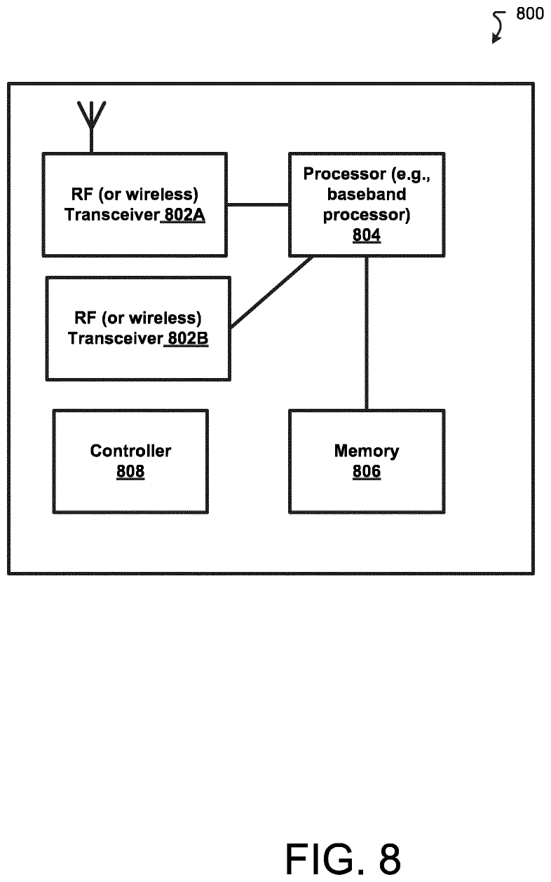

FIG. 8 is a block diagram of a wireless station (e.g., AP, BS, e/gNB, NB-IoT UE, UE or user device) 800 according to an example implementation. The wireless station 800 may include, for example, one or multiple RF (radio frequency) or wireless transceivers 802A, 802B, where each wireless transceiver includes a transmitter to transmit signals (or data) and a receiver to receive signals (or data). The wireless station also includes a processor or control unit/entity (controller) 804 to execute instructions or software and control transmission and receptions of signals, and a memory 806 to store data and/or instructions.

Processor 804 may also make decisions or determinations, generate slots, subframes, packets or messages for transmission, decode received slots, subframes, packets or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8 such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 704, or other controller or processor, performing one or more of the functions or tasks described above.

According to another example implementation, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G uses multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall as intended in the various embodiments.

1.-26. (canceled)

27. An apparatus, comprising:
at least one processor; and
at least one memory including computer program code;
the at least one memory and the computer program code configured to cause the apparatus at least to:
receive, by a user equipment from a location management node for a wireless network, configuration parameters for a set of mobility indicators, the set of mobility indicators providing mobility status information to the location management node;
evaluate, by the user equipment, the configuration parameters to produce the mobility status information;
transmit, by the user equipment to the location management node, the mobility status information;
receive, by the user equipment from the location management node, (i) positioning reference signal configurations for downlink and/or uplink and (ii) positioning measurement and reporting configurations; and
perform, by the user equipment, a positioning measurement according to the positioning reference signal configurations for downlink and/or uplink and according to the positioning measurement and reporting configurations, the positioning measurement being used to determine a position of the user equipment in the wireless network and being reported to the location management node.

28. The apparatus as in claim 27, wherein the at least one memory and the computer program code is further configured to cause the apparatus at least to:
transmit, to the location management node, the positioning measurements, the location management node being configured to derive the position of the user equipment in the network based on the positioning measurements from the user equipment and/or positioning measurements from serving and neighbor network nodes.

29. The apparatus as in claim 27, wherein the set of mobility indicators includes a timing advance update rate, the timing advance update rate indicating a radial movement of the user equipment toward or away from a serving network node available in an RRC_CONNECTED state.

30. The apparatus as in claim 27, wherein the set of mobility indicators includes an autonomous uplink timing adjustment rate, the autonomous uplink timing adjustment rate indicating a radial movement of the user equipment toward or away from a serving network node available in an RRC_CONNECTED state.

31. The apparatus as in claim 27, wherein the set of mobility indicators includes a beam identifier and a change rate of an angle of arrival indicating horizontal and vertical movements of the user equipment relative to a serving cell or neighbour cell location.

32. The apparatus as in claim 27, wherein the set of mobility indicators includes a time of arrival change rate for one or more neighbor cells of the serving cell for the user equipment.

33. The apparatus as in claim 32, wherein the time of arrival change rate is measured during synchronization signal block monitoring of one or more neighbour cells of the serving cell for the user equipment.

34. The apparatus as in claim 27, wherein the set of mobility indicators includes a change rate of a reference signal received power measurement of at least one of a synchronization signal block or a channel state information reference signal.

35. The apparatus as in claim 27, wherein the set of mobility indicators includes a doppler shift estimator.

36. The apparatus as in claim 27, wherein the set of mobility indicators includes an acceleration estimator configured to predict a velocity of the user equipment at the time of the positioning measurement.

37. The apparatus as in claim 27, wherein the set of mobility indicators includes a frequency of cell changes or handovers when the user equipment is in one of RRC_CONNECTED, RRC_INACTIVE or RRC_IDLE state.

38. The apparatus as in claim 27, wherein the configuration parameters for the set of mobility indicators are based on the radio resource connection state of the user equipment.

39. The apparatus as in claim 27, wherein the configuration parameters are evaluated periodically at a specified period of time.

40. The apparatus as in claim 27, wherein the transmission of the mobility status information is performed after the configuration parameters have been evaluated.

41. An apparatus, comprising:
at least one processor; and
at least one memory including computer program code;
the at least one memory and the computer program code configured to cause the apparatus at least to:
transmit, by a location management node for a wireless network to a network node in the wireless network, configuration parameters for a set of mobility indicators, the set of mobility indicators providing mobility status information to the location management node;
receive, by a location management node for a wireless network from a user equipment served by the network node, a set of mobility indicators for the user equipment, the set of mobility indicators for the user equipment providing mobility status information to the location management node for the user equipment in the wireless network; and
generate, by the location management node, positioning reference signal configurations for downlink and/or uplink configured to, with positioning measurement and reporting configurations, provide instructions for the user equipment and network node or set of network nodes to perform positioning measurements to determine a position of the user equipment within the wireless network.

42. The apparatus as in claim 41, wherein the at least one memory and the computer program code is further configured to cause the apparatus at least to:
transmit, by the location management node, (i) positioning reference signal configurations for downlink and/or uplink and (ii) positioning measurement and reporting configurations provided to the user equipment and the network node or set of network nodes; and
receive, from the user equipment and network node or set of network nodes, positioning measurements made by the user equipment and network node or set of network nodes according to the positioning reference signal configurations for downlink and/or uplink and positioning measurement and reporting configurations.

43. The apparatus as in claim 41, wherein the at least one memory and the computer program code configured to generate the positioning reference signal configurations for downlink and/or uplink is further configured to:
select positioning reference signal resources and/or sounding reference signal resources.

44. The apparatus as in claim 41, wherein the instructions for the user equipment and network node or set of network nodes to perform positioning measurements include, in response to the user equipment moving faster than a threshold velocity, instructions to increase a rate of performing positioning measurements.

45. The apparatus as in claim 41, wherein the instructions for the user equipment and network node or set of network nodes to perform positioning measurements include, in response to the user equipment moving faster than a threshold velocity, instructions to set a measurement gap pattern having a periodicity shorter than a threshold time.

46. The apparatus as in claim 41, wherein the instructions for the user equipment and network node or set of network nodes to perform positioning measurements include, in response to the user equipment moving at a velocity faster than a threshold velocity, instructions to assign a different positioning frequency layer for positioning measurements than the positioning frequency layer assigned in case of the velocity at which the user equipment moves is below the threshold velocity.
